(19) United States
(12) Patent Application Publication
(10) Pub. No.: US 2011/0301254 A1
(43) Pub. Date: Dec. 8, 2011

(54) Process for preparing organic silicon compounds

(75) Inventors: Wilfried Knott, Essen (DE); Klaus-Dieter Klein, Muelheim an der Ruhr (DE)

(73) Assignee: Evonik Goldschmidt GmbH, Essen (DE)

(21) Appl. No.: 13/153,622

(22) Filed: Jun. 6, 2011

(30) Foreign Application Priority Data
Jun. 7, 2010 (DE) 102010029723.2

(51) Int. Cl. C08G 77/38; C08G 63/695; C08G 59/14; C08J 9/35; C08G 77/08; C08G 77/46

(52) U.S. Cl. 521/110; 528/19; 525/479; 525/476; 525/523; 521/137; 528/26

(57) ABSTRACT

The invention provides a process for preparing organically modified siloxanes by catalysed reaction of siloxanes having at least one SiH group with a compound having a double bond.

Any foregoing applications, including German patent application DE 10 2010 029 723.2, filed on 7 Jun. 2010, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to a process for adding siloxanes which have SiH groups onto organic compounds with olefinic double bonds in the presence of di-μ-chlorobis(1,2-η)-cyclohexeneplatinum(II) chloride as a catalyst.

The invention relates more particularly to a process for adding siloxanes having SiH groups onto compounds which have olefinic double bonds, for example olefinically unsaturated compounds selected from the group of esters, amines, amides, alcohols, ethers and hydrocarbons.

SiC-bonded, organomodified siloxanes, especially polyethersiloxanes, are an industrially very important substance class given their widely adjustable surfactant performance. The established way of preparing these substances lies in the platinum metal-catalysed addition of siloxanes and silanes bearing SiH groups onto olefinically functionalized compounds, for example onto allyl polyethers.

The use of platinum catalysts for the addition of silanes or siloxanes with SiH groups onto compounds having one or more olefinic double bonds is known (hydrosilylation) and is described, for example, in the book written by Michael. A. Brook “Silicon in Organic, Organometallic, and Polymer Chemistry”, published by John Wiley & Sons, Inc., New York 2000, pages 403 ff., and in the patent literature, for example, in DE-A-26 46 726 (U.S. Pat. No. 4,096,159), EP-A-0 075 703 (U.S. Pat. No. 4,417,068) and U.S. Pat. No. 3,775,452. In current industrial practice, predominantly hexachloroplatinic acid and cis-diamminoplatinum(II) chloride have become established.

The ease with which this reaction principle can be described is often matched by the complexity of performing it reproducibly on the industrial scale.

Firstly, this addition reaction proceeds without significant formation of by-products only when the compounds which have olefinic double bonds are free of groups which can react with the SiH group in competition to the addition reaction.

A particular example of these is the hydroxyl group bonded to carbon.

Secondly, the amounts of platinum metal required (expressed in the form of parts by weight per million parts by weight of the hydrosilylation mixture in question in each case) in order to arrive at useful results, are frequently so high that these processes are no longer of economic interest.

More particularly, however, inadequate SiH conversions lead to undesired molecular weight increase as a result of new formation of SiOSi bonds. As a result of this crosslinking, for example, the viscosity of these products cannot be maintained within the ranges specified, and even the desired surfactant action thereof can experience considerable losses.

Even active catalyst systems, for example those of the Karstedt type (U.S. Pat. No. 3,814,730), in the case of preparation of organomodified siloxanes, especially of the allyl polyether-siloxanes, tend to deactivation and shutdown phenomena, often giving rise to the necessity of further catalysis and/or even of raising the temperature drastically in the addition reaction.

It has also been found in many cases that it is detrimental to the hydrosilylation products when the known platinum catalysts are used above the normal proportions by weight of catalyst and/or at high temperatures. These more severe reaction conditions force the formation of rearranged by-products and promote the activation of the catalyst, for example as a result of irreversible precipitation of noble metal out of the reaction matrix.

The practical utility of products which arise from the platinum metal-catalysed addition reaction of siloxanes bearing SiH groups onto compounds having olefinic double bonds is especially linked directly to the conversion achieved in the hydrosilylation, i.e. the minimization of residual SiH functions. Residual SiH leads, especially in the presence of ubiquitous water traces (for example air humidity) to uncontrollable hydrolysis and crosslinking processes which, especially in the case of addition compounds of high molecular weight, lead inevitably to gelation and make the products unusable.

There has been no lack of efforts in practice, specifically also in the case of the alkylsiloxane-polyethersiloxane copolymers which are used as emulsifiers and are prepared in a multistage addition reaction, to scavenge residual SiH functions by supplementing the reaction matrix with excess ethylene as an SiH-binding auxiliary olefin. However, this measure does not have the desired efficiency, and so approx. 2 to 3% unconverted silicon-hydrogen (based on the starting siloxane) remains. Experience has shown that such a product is not storage-stable and undergoes gelation.

In this context, particularly sensitive indicators for deviations from the quality level are also found, for example, to be those polyethersiloxanes which are used in the production of flexible PU foams as foam stabilizers. The main route to this industrially important class of compounds leads via the noble metal-catalysed addition of allyl alcohol-started polyoxyalkylene compounds (allyl polyethers) onto poly(methylhydrogen)-polydimethylsiloxane copolymers. As practical parameters, both the activity and the cell fineness are criteria for assessment of the stabilizer quality. Process changes in the stabilizer preparation, for example the change in the catalysis conditions during the SiC bond formation reaction, have a direct influence on the foam quality.

The noble metal-catalysed hydrosilylation reaction covers a wide spectrum of modified silanes or siloxanes by virtue of the multitude of possible combinations between silanes or siloxanes containing SiH groups and olefinically unsaturated compounds.

The suitability of di-μ-chlorobis(1,2-η)cyclohexeneplatinum(II) chloride for preparation of organomodified polysiloxanes dissolved in ionic liquids is described in EP 1 382 630 (US 2004-0914925). In Example 9 of the document cited, a short-chain, high-reactivity α,ω-SiH-polydimethylsiloxane of chain length N=20 is heated with 1.3 equivalents of an unsaturated polyether of average molar mass 400 g/mol and of ethyleneglycol content 100% is heated to 90° C. 20 ppm of di-μ-chlorobis(1,2-η)cyclohexeneplatinum(II) chloride dissolved in 1,2,3-trimethylimidazolium methylsulphate are added to this reaction mixture, and the entire reaction batch is stirred at 90° C. for 5 hours. After the reaction batch has been cooled, a phase separation permits the removal of the ABA-structured polyethersiloxane from the 1,2,3-trimethylimidazolium methylsulphate phase containing the platinum complex. EP 1 382 630 does not show that di-μ-chlorobis(1,2-η)cyclohexeneplatinum(II) chloride, without using ionic liquids as an auxiliary phase, is suitable as a catalyst for the preparation of organomodified polysiloxanes. In existing plants for preparing organomodified siloxanes, typically no technical devices for phase separation and for circulation of auxiliary phases are provided, and so the technical teaching being discussed here can be implemented only with considerable inconvenience and capital investment.

In EP 0 073 556 (U.S. Pat. No. 4,427,574), di-μ-chlorobis(1,2-η)cyclohexeneplatinum(II) chloride was combined together with an aliphatically unsaturated organosiloxane compound and an aluminium alkoxide to give a catalyst system which triggers SiC bond formations, the objective of this patent application being the accelerated curing of release coatings based on vinylsiloxane/SiH siloxane systems. The bond formation reaction proceeds in a pure siloxane phase. The task here is not to prepare organomodified siloxanes—and more particularly not those which belong to the class of the polyethersiloxanes—via SiC bond formation. For the production of siloxane derivatives with surfactant properties, in which the polarity difference between the essentially nonpolar siloxanes and the distinctly more hydrophilic addition partners often requires a reaction regime leading away from the initial biphasicity from the start of the reaction, the teaching of EP 0 073 556 (US-Athus does not point the route to a solution.

DE-A 1793494 (U.S. Pat. No. 3,516,946) emphasizes catalyst compositions composed of platinum for hydrosilylation reactions, wherein olefinic chloro complexes of platinum are reacted with cyclic alkylvinylpolysiloxanes with substitution of the olefin originally bonded to the platinum. The alkenylsiloxaneplatinum halide complexes thus obtained are used for the addition of an organopolysiloxane bearing SiH groups onto a further organopolysiloxane having aliphatically unsaturated groups, since they, according to the inventive teaching expressed therein, have an increased system solubility with respect to the olefinic chloro complexes of platinum used as the catalyst reactant.

With U.S. Pat. No. 3,159,601, Ashby already claimed the use of purely olefinic chloro complexes of platinum for the addition of an organopolysiloxane bearing SiH groups onto a further organopolysiloxane having aliphatically unsaturated groups. Neither DE-A 1793494 nor U.S. Pat. No. 3,159,601 shows the suitability of olefinic platinum chloro complexes for the SiC bond-forming preparation of organomodified siloxanes.

DE 1210844 claims the addition of silanes onto unsaturated hydrocarbons to form silicon-containing hydrocarbons. The catalyst di-μ-chlorobis(1,2-η)cyclohexeneplatinum(II) chloride is named as a comparative compound, which leads to a black product in the addition of methyldichlorosilane onto allyl acetate, which indicates the decomposition of the catalyst itself.

It is an object of the present invention to provide an alternative catalyst system in the addition of siloxanes containing SiH groups onto olefinic double bonds.

It has now been found that, surprisingly, aside from the prior art detailed here, the addition of siloxanes having SiH groups onto organic compounds bearing olefinic double bonds succeeds as a result of use of di-μ-chlorobis(1,2-η)cyclohexeneplatinum(II) chloride as a catalyst.

Particularly surprisingly, and entirely unexpectedly for the person skilled in the art, the SiC bond formation reaction caused by use of di-μ-chlorobis(1,2-η)cyclohexeneplatinum(II) chloride as a catalyst even proceeds from the matrix defined by the reaction partners alone, i.e. dispensing with additional solvents or further auxiliary phases which may compatibilize or dissolve the catalyst.

In this context, compatibilization refers to the possibility of homogeneous distribution of the catalyst in the reaction matrix without any need to use additional solvents and/or dispersants for the catalyst. The catalyst can surprisingly display its action even without the presence of an addition of auxiliary phases which dissolve the catalyst or have suspending/emulsifying action.

The invention therefore provides a process for preparing reaction products from siloxanes having SiH groups and organic compounds bearing olefinic double bonds by using di-μ-chlorobis(1,2-η)cyclohexeneplatinum(II) chloride is used as a catalyst.

The di-μ-chlorobis(1,2-η)cyclohexeneplatinum(II) chloride catalyst is present principally in suspended form in the reaction components. The reaction thus takes place in bulk. The reaction partners, i.e. the siloxanes having SiH groups and the organic compounds having olefinic double bonds, and processes for preparation thereof, are known. The archetypes of siloxanes having SiH groups are described in detail, for example, in the standard work “Chemie and Technologie der Silicone” [Chemistry and Technology of the Silicones], written by Walter Noll, Verlag Chemie GmbH, Weinheim/Bergstrasse (1960).

The SiH groups in the siloxanes may be terminal and/or non-terminal.

Siloxanes usable in accordance with the invention are compounds of the general formula (I)

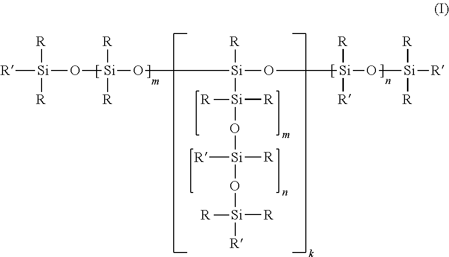

in which
R may be a substituted or unsubstituted hydrocarbyl radical having 1 up to 20 carbon atoms, preferably a methyl group,
R′ may be hydrogen and/or R,
m is 0 to 500, preferably 10 to 200, especially 15 to 100,
n is 0 to 60, preferably 0 to 30, especially 0.1 to 25,
k is 0 to 10, preferably 0 to 4,
   with the proviso that at least one R′ is hydrogen.

The siloxanes are industrial products in which the individual constituents of the parts shown in brackets in the general formula (I) may be present in random or blockwise distribution; they may, as a result of the preparation, also contain relatively high proportions of branches. The compounds preferred in accordance with the invention are essentially linear. In proportions of 50% by weight, preferably >90% by weight, the R radicals are short-chain alkyl radicals, especially methyl radicals.

Preferred R radicals are one or more identical or different groups which do not hinder the addition reaction, such as alkyl groups having 1 to 8 carbon atoms; substituted alkyl groups having 1 to 8 carbon atoms, such as 3-chloropropyl, 1-chloromethyl, 3-cyanopropyl groups; aryl groups such as the phenyl group; aralkyl groups having 7 to 20 carbon atoms, such as the benzyl group; alkoxy or alkoxyalkyl groups, such as the ethoxy or ethoxypropyl group. Within one molecule of the formula (I), the R radical may also have different meanings. Preference is given, however, to compounds in which all R radicals or the predominant number thereof are defined as a methyl radical.

Examples of suitable preferred siloxanes having SiH groups are compounds of the formula (II) or (III):

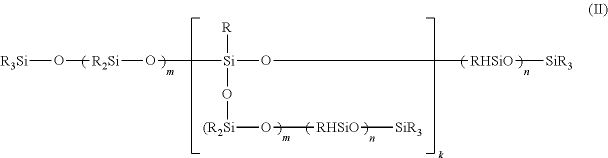

where k, m, n and R are each defined under formula (I) and R₂ and R₃ may be hydrogen and/or R′;

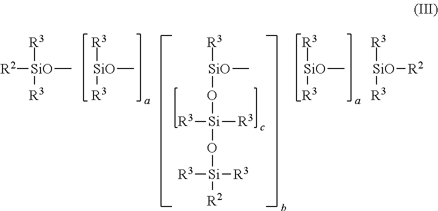

where
R³ in the average molecule are alkyl radicals having 1 to 18 carbon atoms or aryl radicals, but at least 90% of the R radicals are methyl radicals,
R² are as defined for the R³ radicals or are hydrogen radicals, where at least 2 R² radicals in the average molecule must be hydrogen radicals,
a has a value of 0.5 to 100,
b has a value of 0 to 5 and
c has a value of 0 to 100.

Particular preference is given to hydropolysiloxanes in which R² are hydrogen radicals and R³ are methyl radicals, a has a value of 0.5 to 5, b has the value of 0 and c has a value of 1 to 10.

The olefinically unsaturated organic compounds are preferably selected from the group of the α-olefins, the strained ring olefins, the α,ω-alkenols, the terminally olefinically unsaturated polyethers, the amino-functional α-olefins or the oxiranes bearing α-olefin groups, and from the group of the carboxylic esters olefinically unsaturated in the ω position, or else from mixed systems of the substance classes listed here.

The α-olefins are branched or unbranched α-olefins which have 2-18 carbon atoms and are mono- or polyunsaturated, preference being given to ethylene, 1-propene, 1-butene, isobutene, and particular preference to hexene, octene, decene, undecene, hexadecene, octadecene and α-olefins in the carbon number range of C₂₀-C₄₀, and also the C₂₂-C₂₄-olefin cuts which are generally industrially available from petrochemistry.

The olefinically unsaturated compounds can each be used alone or in any desired mixtures with further olefinically unsaturated compounds. When mixtures are used, the reaction forms copolymer compounds of blockwise or random structure, according to whether the unsaturated compounds are metered into the SiH siloxane simultaneously or at different times or alternately. The person skilled in the art is aware of the selection criteria under which the olefins should be selected in order to arrive at particularly advantageous product properties. Especially in the case of mixtures of different olefins, the person skilled in the art is able to assess side reactions of different functional groups of the mixture components and in some cases to suppress them. For example, the mixture of an amino-functional olefin with an olefin group-bearing oxirane will lead to the unavoidable side reaction of amino group and oxirane ring with ring opening.

Strained ring olefins which should be named specifically are the derivatives of norbornene and of norbornadiene, of dicyclopentadiene, and the unsubstituted base structures thereof.

The α,ω-alkenols are branched or unbranched α,ω-alkenols having 2-18 carbon atoms, which are monounsaturated. For the class of the α,ω-alkenols, preference is given to 5-hexen-1-ol and 9-decen-1-ol.

Terminally olefinically unsaturated polyethers are understood to mean those polyoxyalkylene compounds whose unsaturated terminus is defined by a vinyl, allyl or methallyl group.

Examples thereof are polyoxyalkylene compounds of the formulae

CH₂═CH—CH₂—O—(CH₂—CH₂O—)ₓ—CH₂—CH(R′)O—)_{y}(SO)_{z}—R″ (IV)

CH₂═CH—O—(CH₂—CH₂O—)ₓ—CH₂—CH(R′)O—)_{y}—R″ (V)

CH₂═CH—CH₂—R^{IV} (VI)

CH₂═CH—(O)ₓ—R^{IV} (VII)

in which
x=0 to 100,
x′=0 or 1,
y=0 to 100,
z=0 to 100,
R′ is an optionally substituted alkyl group having 1 to 4 carbon atoms and
R″ is a hydrogen radical or an alkyl group having 1 to 4 carbon atoms; the —C(O)—R′″ group where R′″=alkyl radical;
   the —CH₂—O—R′ group; an alkylaryl group, such as the benzyl group; the —C(O)NH—R′ group,
R^{IV} is an optionally substituted hydrocarbyl radical having 7 to 47 and preferably 13 to 37 carbon atoms,
SO is the C₆H₅—CH(—)—CH₂—O— radical.

The amino-functional α-olefins are understood here especially to mean allylamine and N-ethylmethallylamine.

In the teaching of U.S. Pat. No. 4,892,918, Ryang reveals hexachloroplatinic acid to be that hydrosilylation catalyst which is the most suitable for the preparation of secondary amino-functional siloxanes. Surprisingly, this synthesis, however, also succeeds with the di-μ-chlorobis(1,2-η)cyclohexeneplatinum(II) chloride catalyst presented here. The reaction in U.S. Pat. No. 4,892,918 is likewise performed in bulk, i.e. without presence of solvents or other auxiliary phases, but the reaction of the amino-functional siloxanes, with knowledge of the inventive concept being presented here, suggests that the hexachloroplatinic acid is converted by the amino functions to a partly dissolved form, which then leads to an active catalyst system in a comparable manner to di-μ-chlorobis(1,2-η)cyclohexeneplatinum(II) chloride.

However, the examples of U.S. Pat. No. 4,892,918 show that long reaction times have to be accepted.

Surprisingly, such a reaction succeeds with the process which is the subject of this invention and with the di-μ-chlorobis(1,2-η)cyclohexeneplatinum(II) chloride catalyst both with the amine-functional reactants and without the presence of groups which are inherently present in the molecular structure and act as auxiliary phase mediators. Even at high reaction temperatures while ensuring comparatively short reaction times at high conversion rates, virtually colourless (clear to the human eye) reaction products are obtained in the process which is the subject of this invention (see Examples 5 and 7 for amino-functional substrates and the further inventive examples).

Moreover, the reaction of the invention which utilizes di-μ-chlorobis(1,2-η)cyclohexeneplatinum(II) chloride catalyst is also distinguished by: (1) not needing an ionic liquid as an auxiliary phase; or (2) a co-catalyst such as aluminium alkoxide; or (3) requiring a further workup or purification step after the reaction between the reactants and di-μ-chlorobis(1,2-η)cyclohexeneplatinum(II) chloride catalyst is complete.

Entirely nonlimiting representatives of this substance group of the oxiranes provided with addition-capable olefinic functions which shall be mentioned here are allyl glycidyl ether and vinylcyclohexene oxide.

Among the carboxylic esters which are olefinically unsaturated in the ω position are those such as the industrially readily available methyl undecylenoate, for example.

The hydrosilylation reaction is preferably undertaken with a certain excess of at least about 15 mol % of alkenes, based on one SiH group. In the case of unsaturated polyethers, especially allyl polyethers, as reactants, industrially customary excesses of approximately 30-40 mol % are selected. Solvents need not be used, but are not disruptive if they are inert in relation to the reaction. The reaction temperature is generally and preferably about 140° C. to 160° C. The reaction time is 1 to 8 and preferably 1 to 3 hours.

Suitable solvents usable optionally are all organic solvents which are inert under reaction conditions, especially hydrocarbons, for example aliphatic, cycloaliphatic and optionally substituted aromatic hydrocarbons, for example pentane, hexane, heptane, cyclohexane, methylcyclohexane, decalin, toluene, xylene, etc. The solvents used may also be the reactants inherent to the reaction system, and also the reaction products themselves. The catalyst is used in the system-dependent concentrations typical of hydrosilylation reactions.

The amount of platinum catalyst di-μ-chlorobis(1,2-η)cyclohexeneplatinum(II) chloride to be used is guided essentially by the reactivity and the molecular weight of the reactants. In general, 10⁻² to 10⁻⁸ mol and preferably 10⁻³ to 10⁻⁶ mol of the catalyst is used for in each case 1 mol of SiH groups in the siloxane.

The inventive catalyst can be used over a wide temperature range. To avoid the product-damaging side reactions detailed in the prior art, the temperature range is preferably selected at such a low level that it constitutes an acceptable compromise between desired product purity and production performance. To achieve higher throughput rates, the reaction temperature can also be increased considerably (to approx. 150° C.), without deactivation and shutdown phenomena.

The linear polydimethylsiloxanes which have amino groups and are obtained in accordance with the invention can be used for treatment of textiles in order to impart a soft hand and certain antistatic properties thereto.

In addition, the linear polydimethylsiloxanes which have amino groups and are obtained by the process according to the invention, by virtue of the further reaction thereof with, for example, polypropylene oxides bearing α,ω-epoxy functions, and diamines, for example piperazine, permit the formation of wash liquor additives which improve soft hand, as detailed in the patent application DE 10 2010 001350.1, which was yet to be published at the priority date of the present application.

The compounds obtained in accordance with the invention can, however, especially be used as reactive components for preparing polymeric compounds:

One possible use is to use them as a crosslinking component in epoxy resins for improving the toughness of the epoxy resins, especially at low temperatures, e.g. below 0° C.

A further end use is the reaction thereof with siloxanes which have terminal epoxy groups in order to obtain polymers which are used for coating of textiles. These coatings impart a soft hand to the textiles.

Typically, the reactions claimed in accordance with the invention proceed under atmospheric pressure, but are optionally also performed under elevated pressure.

Preferably in accordance with the invention, the process is performed at standard pressure, but pressure ranges deviating therefrom are likewise possible—if desired.

The organosiloxanes prepared in accordance with the invention can be used in place of the organomodified organosiloxanes and aqueous systems based thereon which are used for all respective applications in the household and in industry but are prepared commercially, and in cleansing and care compositions for skin and skin appendages, and in cleaning and care formulations for pharmaceutical, domestic and industrial use. Owing to the extremely advantageous rheological properties, they are additionally also usable for fields of application which have been inaccessible to date.

Nonexclusive examples are pigment wetting agents or dispersing additives for producing homogeneous, storage-stable pastes, inks, lacquers, covers, coatings, paints; in antitranspirants/deodorants, and in pharmaceutical formulations.

The invention further provides for the use of the organosiloxanes prepared in accordance with the invention in compositions for cleaning and care of hard surfaces, and for modifying, cleaning and care of textiles.

The invention further provides for the use of the organomodified organosiloxanes prepared by the process in the treatment and aftertreatment of textiles, for example as cleaning and care compositions, as impregnating agents, finishing aids and hand improvers and textile softeners.

The invention further provides for the use of the organosiloxanes prepared in accordance with the invention, especially of the silicone polyether copolymers, in the production of polyurethane foams, for example as foam stabilizers, cell openers, separating agents, etc. The process is generally performed in such a way that the SiH compounds a) are reacted at least partly, i.e. substantially, but preferably substantially completely, with the double bond of component b).

The invention further provides for the use of the organically modified siloxanes in the preparation of polyesters and polyurethanes. More particularly, the organically modified siloxanes containing amino functions can function as the soft segment in the molecule in the preparation of polyesters and polyurethanes.

Further subjects of the invention are described in the claims, the disclosure-content of which in its entirety is part of this description.

In the examples adduced below, the present invention is described to illustrate the invention, without any intention that the invention, the range of application of which is evident from the overall description and the claims, be restricted to the embodiments mentioned in the examples. When ranges, general formulae or compound classes are specified in this description or the examples, these shall encompass not only the corresponding ranges or groups of compounds mentioned explicitly, but also all sub-ranges and sub-groups of compounds which can be obtained by selection of individual values (ranges) or compounds. When documents are cited in the context of the present description, the content thereof in its entirety shall form part of the disclosure-content of the present invention. When compounds, for example organomodified siloxanes, which may have more than one instance of different monomer units are described in the context of the present invention, these different monomer units may occur in random distribution (random oligomer) or in ordered form (block oligomer) in these compounds. Figures for the number of units in such compounds should be understood as statistical averages, averaged over all corresponding compounds.

### EXPERIMENT SECTION

The examples adduced here serve to illustrate the process claimed in accordance with the invention.

The SiH values of the hydrosiloxanes used, but also those of the reaction matrices, are in each case determined by gas volumetric means, by the sodium butoxide-induced decomposition of weighed sample aliquots in a gas burette. Inserted into the general gas equation, the hydrogen volumes measured permit the determination of the content of active SiH functions in the reactants, but also in the reaction mixtures, and thus allow monitoring of conversion.

The molecular weights of the allyl alcohol-started polyethers used (Examples 1 and 6), but also of the technical α-olefin (Example 2), were determined by the titration of the iodine number according to Hanus, which has long formed part of the C-V section of the “DGF-Einheitsmethoden [Standard methods of the German Society for Fat Science] (cf. Fat Sci. Technol. 1991, No. 1, pages 13-19 and DGF C-V 11 a (53) and Ph. Eur. 2.5.4 (Method A).

The catalyst used in accordance with the invention can be purchased commercially from W.C. Heraeus, Hanau, Germany.

The viscosities reported are determined by measurement in a Haake viscometer as dynamic shear viscosities to DIN 53921.

### Example 1

### Preparation of a Silicone Polyether Copolymer

In a 1 l multineck round-bottom flask with internal thermometer, precision glass stirrer and reflux condenser, 410 g of an allyl alcohol-started polyether having a mean molecular weight of approx. 1840 g/mol and propylene oxide content approx. 80% and iodine number 13.8 are heated to 100° C. while stirring together with 130 g of a polydimethylsiloxane-polymethylhydrosiloxane copolymer of mean molecular weight 5100 g/mol and SiH value 1.27 mol/kg. 24 mg of di-μ-chlorobis(1,2-η)cyclohexeneplatinum(II) chloride are added, and the reaction mixture is kept at 100° C. for a further 3 hours.

A sample taken for SiH determination by gas volumetric means (determination of the hydrogen evolved in the decomposition of an aliquot with the aid of a sodium butoxide solution in a gas burette) confirms quantitative SiH conversion. After cooling, a virtually colourless silicone polyether copolymer with a viscosity of 920 mPas is obtained.

Surprisingly, the reaction proceeds very rapidly at comparatively high temperature, and especially without formation of (coloured) by-products. A complex purification of the product can therefore be dispensed with.

### Example 2

### Preparation of a Silicone Wax

In a 1 l multineck round-bottom flask with internal thermometer, attached dropping funnel, precision glass stirrer and reflux condenser, 316 g of an α-olefin having a mean molecular weight of approx. 350 g/mol are heated to 130° C. while stirring, and 17 mg of di-μ-chloro-bis(1,2-η)cyclohexeneplatinum(II) chloride are added. 50 g of a polymethylhydrosiloxane having an SiH content of 15.7 mol/kg are added from the dropping funnel over the course of 1.5 hours. The reaction, which is characterized by strong exothermicity, has ended after 2 hours. The SiH determination by gas volumetric means (determination of the hydrogen evolved in the decomposition of an aliquot with the aid of a sodium butoxide solution in a gas burette) shows complete conversion. After cooling, a colourless silicone wax with a melting point of 68° C. is isolated.

### Example 3

### Preparation of an Alkenol-Silicone Addition Product

In a 500 ml multineck round-bottom flask with internal thermometer, attached dropping funnel, precision glass stirrer and reflux condenser, 164.5 g of 5-hexen-1-ol are heated to 85° C. while stirring vigorously, and 18 mg of di-μ-chlorobis(1,2-η)cyclohexeneplatinum(II) chloride are added. 230 g of an α,ω-dihydropolydimethylsiloxane-polymethylhydrosiloxane copolymer with an SiH content of 5.5 mol/kg are added from the dropping funnel at such a rate that the reaction temperature does not rise above 120° C. The strongly exothermic reaction has ended after 3 hours. The SiH determination by gas volumetric means (determination of the hydrogen evolved in the decomposition of an aliquot with the aid of a sodium butoxide solution in a gas burette) shows complete conversion. After cooling, a colourless alkenol-silicone addition product with a viscosity of 2100 mPas is isolated.

### Example 4

### Preparation of a Methyl Undecylenoate-Modified Silicone Wax

In a 500 ml multineck round-bottom flask with internal thermometer, attached dropping funnel, precision glass stirrer and reflux condenser, 190.0 g of a polydimethylsiloxane-polymethylhydrosiloxane copolymer having an SiH content of 3.54 mol/kg are heated to 110° C. while stirring, and 21 mg of di-μ-chlorobis(1,2-η)cyclohexeneplatinum(II) chloride are added. A mixture consisting of 107 g of methyl undecylenoate and 174 g of hexadecene is added from the dropping funnel at such a rate that the reaction temperature does not rise above 120° C. The strong exothermic reaction has ended after 3.5 hours. The SiH determination by gas volumetric means (determination of the hydrogen evolved in the decomposition of an aliquot with the aid of a sodium butoxide solution in a gas burette) shows complete conversion. After cooling, a colourless polymer with a viscosity of 410 mPas is isolated.

### Example 5

### Preparation of an Amino-Functionalized Polydimethylsiloxane

In a 500 ml multineck round-bottom flask with internal thermometer, attached dropping funnel, precision glass stirrer and reflux condenser, 160.3 g of an α,ω-dihydro-polydimethylsiloxane with an SiH content of 3.00 mol/kg are heated to 145° C. with vigorous stirring, and 10 mg of di-μ-chlorobis(1,2-η)cyclohexeneplatinum(II) chloride are added. The dropping funnel is used to meter in 62 g of N-ethylmethallylamine at such a rate that the reaction temperature remains below 160° C. As early as 1 hour after metered addition has ended, an SiH determination by gas volumetric means on a sample taken confirms complete conversion. After the reflux condenser has been exchanged for a distillation system, the mixture is freed of volatile constituents at bottom temperature 150° C. and pressure 10 mbar. After cooling, a virtually colourless, amino-functional polydimethylsiloxane is isolated, which has a viscosity of 10 mPas.

Surprisingly, the reaction proceeds very rapidly at comparatively high temperature, and especially without formation of (coloured) by-products. Specifically the gelated, highly coloured products which frequently occur in the case of amino-functional siloxanes are not obtained. A complex purification of the product can therefore be dispensed with.

### Example 6

### Preparation of an Epoxy-Modified Silicone Polyether

In a 500 ml multineck round-bottom flask with internal thermometer, attached dropping funnel, precision glass stirrer and reflux condenser, 200.0 g of a polydimethylsiloxane-polymethylhydrosiloxane copolymer having an SiH content of 1.55 mol/kg are heated to 100° C. with vigorous stirring and addition of 0.05% sodium carbonate together with 125.0 g of a polyalkenol of mean molecular weight of approx. 500 g/mol and propylene oxide content approx. 50% and iodine number 49, and then 15 mg of di-μ-chlorobis(1,2-η)-cyclohexeneplatinum(II) chloride are added. After the SiC bond formation reaction, which is characterized by exothermicity, has abated, 13.8 g of allyl glycidyl ether are slowly added dropwise. As early as one hour after addition has ended, the reaction conversion determined by gas volumetric means is quantitative. After exchanging the reflux condenser for a distillation system, the mixture is freed of volatiles at 130° C. and pressure 10 mbar. After filtration and cooling, a virtually colourless copolymer with a viscosity of 740 mPas is obtained.

### Example 7

### Preparation of a Polydimethylsiloxane Bearing α,ω-Aminopropyl Groups (Inventive)

In a 500 ml multineck round-bottom flask with internal thermometer, attached dropping funnel, precision glass stirrer and reflux condenser, 160.3 g of an α,ω-dihydro-polydimethylsiloxane with an SiH content of 3.00 mol/kg are heated to 145° C. while stirring vigorously, and 30 ppm of di-μ-chlorobis(1,2-η)cyclohexeneplatinum(II) chloride are added. The dropping funnel is used to meter in 148.2 g of allylamine at such a rate that the reaction temperature remains below 160° C. As early as 4 hours after commencement of metered addition, an SiH determination by gas volumetric means on a sample taken confirms complete conversion. After the reflux condenser has been exchanged for a distillation system, the mixture is freed of volatile constituents at bottom temperature 150° C. and pressure 10 mbar. After cooling, a virtually colourless, amino-functional polydimethylsiloxane is isolated, which has a viscosity of 14 mPas and, according to ²⁹Si NMR analysis, consists to an extent of approx. 75% of α-addition product and to an extent of approx. 25% of β-addition product.

### Example 8

### Preparation of a Polydimethylsiloxane Bearing α,ω-Aminopropyl Groups (Not Inventive)

In analogy to Example 7, in a 500 ml multineck round-bottom flask with internal thermometer, attached dropping funnel, precision glass stirrer and reflux condenser, 160.3 g of an α,ω-dihydropolydimethylsiloxane with an SiH content of 3.00 mol/kg are heated to 145° C. while stirring vigorously, and 30 ppm of the platinum-pyridine catalyst (Pt(pyridine)(ethylene)Cl₂) are added. The dropping funnel is used to meter in 148.2 g of allylamine at such a rate that the reaction temperature remains below 160° C. Not until 32 hours after commencement of metered addition is complete conversion detectable by an SiH determination by gas volumetric means on a sample taken. After the reflux condenser has been exchanged for a distillation system, the mixture is freed of volatile constituents at bottom temperature 150° C. and pressure 10 mbar. After cooling, a dark yellow-brownish, amino-functional polydimethylsiloxane is isolated, which has a viscosity of 18 mPas. The corresponding ²⁹Si NMR spectrum shows a selectivity of the SiC bond formation as in Example 7, i.e. approx. 75% α-addition product and approx. 25% β-addition product. Compared to Inventive Example 7, the quality difference is clear in this example. The isomer distribution in the product is comparable to Example 7, but a significantly longer reaction time is observed.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. Process for preparing reaction products from siloxanes having SiH groups and organic compounds bearing olefinic double bonds, characterized in that di-μ-chlorobis(1,2-η)cyclohexeneplatinum(II) chloride is used as a catalyst.

2. Process according to claim 1, characterized in that a reaction is carried out without solvent and without auxiliary phases which compatibilize or dissolve the catalyst.

3. Process according to either of claims 1 and 2, characterized in that the siloxanes bearing Si—H groups used are those of the formula (I) 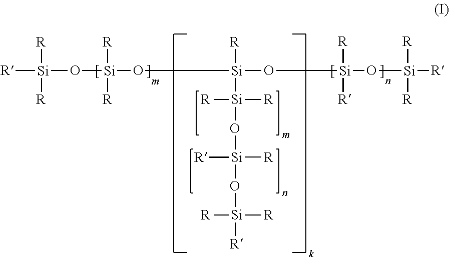
in which
R is a substituted or unsubstituted hydrocarbyl having 1 up to 20 carbon atoms,
R′ is hydrogen and/or R,
m is 0 to 500,
n is 0 to 60,
k is 0 to 10,
with the proviso that at least one R′ is hydrogen.

4. Process according to claim 3, characterized in that the R radical of the formula (I) is selected from one or more identical or different groups from the alkyl groups having 1 to 8 carbon atoms, substituted alkyl groups having 1 to 8 carbon atoms, 3-chloropropyl, 1-chloromethyl, 3-cyanopropyl group, aryl groups, phenyl group, aralkyl groups having 7 to 20 carbon atoms, benzyl group, alkoxy or alkoxyalkyl groups, ethoxy or ethoxypropyl group.

5. Process for preparing organically modified siloxanes according to at least one of claims 1 to 4, characterized in that the olefinically unsaturated organic compounds are selected from the group of the α-olefins, the strained ring olefins, the α,ω-alkenols, the terminally olefinically unsaturated polyethers, the amino-functional α-olefins or the oxiranes bearing α-olefin groups, or the carboxylic esters olefinically unsaturated in the ω position, where the olefins can be used alone or in any desired mixtures with one another.

6. Method for preparing polymeric compounds characterized in the reaction product according to claim 16 is added during the preparation of polymeric compounds.

7. Method for improving the toughness of epoxy resins by adding the reaction product according to claim 16 as a crosslinking component in epoxy resins.

8. Method according to claim 7, wherein the reaction product comprises organically modified siloxanes which have terminal epoxy groups, and the prepared polymers are used for coating of textiles.

9. Method for preparing compositions for use in household and industry, cleansing and care for skin and skin appendages, cleaning and care of hard surfaces, modifying, cleaning, and care of textiles, and cleaning and care for pharmaceutical, domestic and industrial use characterized that the composition is prepared using a reaction product according to claim 16.

10. Method according to claim 9, wherein the reaction product is used as pigment wetting agent or dispersing additive for producing homogeneous, storage-stable pastes, inks, lacquers, covers, coatings, paints, in anti-perspirants/deodorants, and in pharmaceutical formulations.

11. Method according to claim 9, characterized in that the composition is used in the treatment and aftertreatment of textiles, as cleaning and care compositions, as impregnating compositions, finishing aids and hand improvers, and textile softeners.

12. Method according to claim 6 characterized in that the polymeric compound is a polyurethane foam.

13. Method according to claim 6 characterized in that the polymeric compound is a polyester.

14. Method according to claim 6 characterized in that the reaction product comprises organically modified siloxanes containing amino functions.

15. Reaction product comprising the product of a process according to claim 1, characterized in that the product comprises the compounds obtained by reacting of siloxanes having SiH groups with organic compounds bearing olefinic double bonds and di-μ-chlorobis(1,2-η)cyclohexeneplatinum(II) chloride.

16. Reaction product according to claim 15, further comprising siloxanes having SiH groups and organic compounds bearing olefinic double bonds.

17. Reaction product according to claim 16, consisting of compounds obtained by reacting of siloxanes having SiH groups with organic compounds bearing olefinic double bonds and di-μ-chlorobis(1,2-η)cyclohexeneplatinum(II) chloride and optionally siloxanes having SiH groups and organic compounds bearing olefinic double bonds.
